(19) United States
(12) Patent Application Publication
(10) Pub. No.: US 2023/0299540 A1
(43) Pub. Date: Sep. 21, 2023

(54) LEVER-TYPE CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Daisuke SAITO, Mie (JP)

(21) Appl. No.: 18/022,025

(22) PCT Filed: Jul. 30, 2021
(86) PCT No.: PCT/JP2021/028318

§ 371 Date: Feb. 17, 2023

(30) Foreign Application Priority Data
Sep. 7, 2020 (JP) 2020-149569

(51) Int. Cl. H01R 13/629; H01R 13/642; H01R 13/639

(52) U.S. Cl. CPC H01R 13/62938; H01R 13/642; H01R 13/639

(57) ABSTRACT

It is aimed to connect a first housing and a second housing in an opposed state and detect connection of the housings. A lever-type connector includes a cam follower formed on a second housing and configured to connect the first and second housings by sliding in contact with a cam groove in a rotation process of a lever from an initial position to a connection position, a restricting pin provided on the first housing and arranged at a position deviated in a direction intersecting a connecting direction with respect to a virtual connection line, a restricting groove to be brought into sliding contact with the restricting pin, and a connection detector for allowing the lever to slide to a connection detecting position eccentric from a center of rotation only when the lever reaches the connection position and the first and second housings are connected in an opposed positional relationship.

### TECHNICAL FIELD

The present disclosure relates to a lever-type connector.

### BACKGROUND

Patent Document 1 discloses a lever-type connector in which a first housing and a second housing are connected by rotating a lever mounted on a lever support shaft of the first housing. In a connection process of the both housings, a cam groove of the lever and a cam shaft of the second housing slide in contact and the both housings are pulled toward each other by the inclination of the cam groove.

### PRIOR ART DOCUMENT

### Patent Document

### Patent Document 1: JP 2012-243669 A

### SUMMARY OF THE INVENTION

### Problem to be Solved

A clearance for making a connecting operation of the both housings smooth is provided between a rotary shaft of the first housing and a bearing hole of the second housing. The cam groove is oblique to a connecting direction of the both housings. Thus, the first and second housings may be connected while being oblique to each other with the cam shaft as a fulcrum. Further, the above lever-type connector does not have a function of detecting the connection of the first and second housings.

A lever-type connector of the present disclosure was completed on the basis of the above situation and aims to connect a first housing and a second housing in an opposed state and enable the detection of the connection of the both housings.

### Means to Solve the Problem

The present disclosure is directed to a lever-type connector with a first housing, a second housing connectable to the first housing, a lever including a cam groove, the lever being mounted rotatably between an initial position and a connection position with respect to the first housing, a cam follower formed on the second housing, the cam follower connecting the first and second housings by sliding in contact with the cam groove in a rotation process of the lever from the initial position to the connection position, a restricting pin provided on the first housing, the restricting pin being arranged at a position deviated in a direction intersecting a connecting direction of the first and second housings with respect to a virtual connection line passing through a center of rotation of the lever and parallel to the connecting direction, a restricting groove formed in the lever, the restricting groove having an arcuate shape concentric with the center of rotation of the lever, the restricting pin sliding in contact with the restricting groove in the rotation process of the lever, and a connection detector for allowing the lever to slide to a connection detecting position eccentric from the center of rotation only when the lever reaches the connection position and the first and second housings are connected in an opposed positional relationship.

### Effect of the Invention

According to the present disclosure, the first and second housings can be connected in an opposed state and the connection of the both housings can be detected.

### BRIEF DESCRIPTION OF THE DRAWINGS

FIG. 1 is an exploded perspective view of a lever-type connector of one embodiment.

FIG. 2 is a perspective view showing a state before a second housing is assembled with a first housing and a lever.

FIG. 3 is a right side view of the lever-type connector when the lever is at an initial position.

FIG. 4 is a section of the lever-type connector of FIG. 3 when viewed from right.

FIG. 5 is a section of the lever-type connector of FIG. 3 when viewed from above.

FIG. 6 is a right side view of the lever-type connector during a movement of the lever from the initial position to a connection position.

FIG. 7 is a right side view of the lever-type connector when the lever is at the connection position.

FIG. 8 is a section of the lever-type connector of FIG. 7 when viewed from left.

FIG. 9 is a right side view of the lever-type connector when the lever is at a connection detecting position.

FIG. 10 is a plan view of the lever-type connector when the lever is at the connection position.

FIG. 11 is an enlarged view enlargedly showing a lock arm and its peripheral part in FIG. 10.

FIG. 12 is a view, equivalent to FIG. 11, when the lever is at the connection detecting position.

FIG. 13 is a section along A-A of FIG. 12.

FIG. 14 is a bottom view of the lever-type connector when the lever is at the connection position.

FIG. 15 is a bottom view of the lever-type connector when the lever is at the connection detecting position.

### DETAILED DESCRIPTION TO EXECUTE THE INVENTION

### Description of Embodiments of Present Disclosure

First, embodiments of the present disclosure are listed and described.

(1) The lever-type connector of the present disclosure is provided with a first housing, a second housing connectable to the first housing, a lever including a cam groove, the lever being mounted rotatably between an initial position and a connection position with respect to the first housing, a cam follower formed on the second housing, the cam follower connecting the first and second housings by sliding in contact with the cam groove in a rotation process of the lever from the initial position to the connection position, a restricting pin provided on the first housing, the restricting pin being arranged at a position deviated in a direction intersecting a connecting direction of the first and second housings with respect to a virtual connection line passing through a center of rotation of the lever and parallel to the connecting direction, a restricting groove formed in the lever, the restricting groove having an arcuate shape concentric with the center of rotation of the lever, the restricting pin sliding in contact with the restricting groove in the rotation process of the lever, and a connection detector for allowing the lever to slide to a connection detecting position eccentric from the center of rotation only when the lever reaches the connection position and the first and second housings are connected in an opposed positional relationship.

According to the configuration of the present disclosure, a force to make the first and second housings oblique with the cam follower as a fulcrum acts on the first and second housings being connected. However, the first and second housings can be prevented from becoming oblique by the contact of the restricting pin and the restricting groove. If the lever rotates to the connection position, the first and second housings are connected in an opposed state and the lever can be slid to the connection detecting position. According to the present disclosure, the first and second housings can be connected in the opposed state and the connection of the both housings can be detected.

(2) Preferably, the connection detector includes a cam-side recess formed by partially recessing the cam groove, the cam follower entering the cam-side recess in the process of sliding the lever to the connection detecting position. According to this configuration, the connection of the both housings can be detected using the cam follower.

(3) Preferably, the first housing is formed with a second restricting pin arranged at a position different from the restricting pin, and the lever is formed with a second restricting groove having an arcuate shape concentric with the center of rotation of the lever and configured such that the second restricting pin slides in contact therewith in the rotation process of the lever. According to this configuration, an event in which the first and second housings become oblique with the cam follower as a fulcrum can be reliably prevented by the contact action of the second restricting pin and the second restricting groove in addition to the contact action of the restricting pin and the restricting groove.

(4) Preferably, in (3), the connection detector includes a detection recess formed by partially recessing the second restricting groove, the second restricting pin entering the detection recess in the process of sliding the lever to the connection detecting position. According to this configuration, the connection of the both housings can be detected using the second restricting pin.

(5) Preferably, the first housing is formed with a rotary shaft constituting the center of rotation of the lever by being fit into a bearing hole of the lever, and the connection detector includes a shaft-side recess formed by partially recessing the bearing hole, the rotary shaft entering the shaft-side recess in the process of sliding the lever to the connection detecting position. According to this configuration, the connection of the both housings can be detected using the rotary shaft.

(6) Preferably, the first or second housing is formed with a rotation restricting portion for restricting rotation of the lever toward the initial position with the lever slid to the connection detecting position. According to this configuration, since the rotation of the lever toward the initial position is restricted by the rotation restricting portion if the lever is slid to the connection detecting position, the first and second housings can be maintained in a connected state.

(7) Preferably, the lever is formed with a return restricting portion for restricting return of the lever to a rotation operation position where a rotation operation is performed by being locked to the first housing when the lever is slid to the connection detecting position. According to this configuration, the lever can be held at the connection detecting position.

(8) Preferably, in (7), the second housing is formed with an initial position holding portion for holding the lever at the initial position by being locked to the return restricting portion. According to this configuration, the shape of the lever can be simplified as compared to the case where a dedicated part for holding the lever at the initial position is formed separately from the return restricting portion.

### DETAILS OF EMBODIMENT OF PRESENT DISCLOSURE

### Embodiment

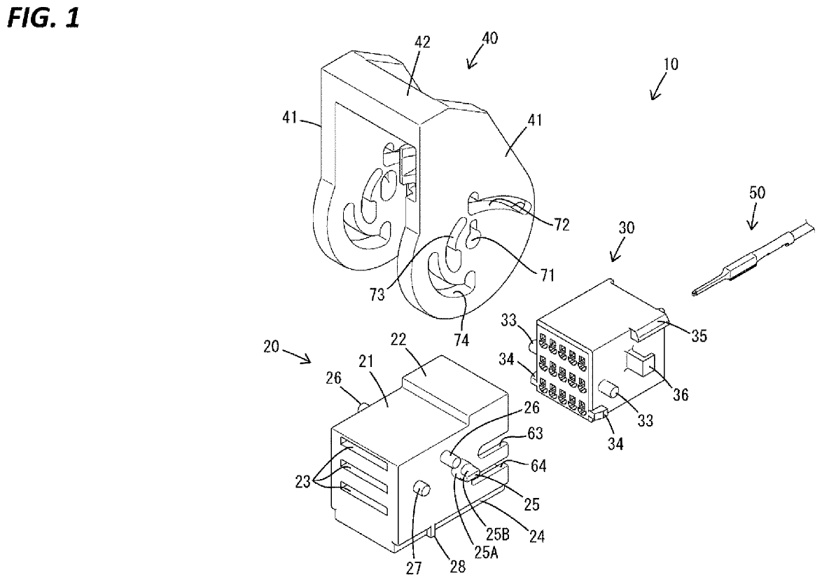

A specific embodiment of a lever-type connector of the present disclosure is described with reference to FIGS. 1 to 15. In this embodiment, upper and lower sides shown in FIGS. 1 to 4, 6 to 9 and 13 are directly defined as upper and lower sides concerning a vertical direction. Left and right sides shown in FIGS. 1 to 12, 14 and 15 are respectively defined as front and rear sides concerning a front-rear direction. A lateral direction is synonymous with a width direction, and front and rear sides shown in FIGS. 1 to 12, 14 and 15 are defined as right and left sides.

(Configuration of Lever-Type Connector)

A lever-type connector 10 of this embodiment is, as shown in FIG. 1, provided with a first housing 20, a second housing 30, a lever 40, male terminal fittings 50 and female terminal fittings (not shown). The first housing 20 and the second housing 30 are connectable. The lever 40 is mounted rotatably with respect to the first housing 20.

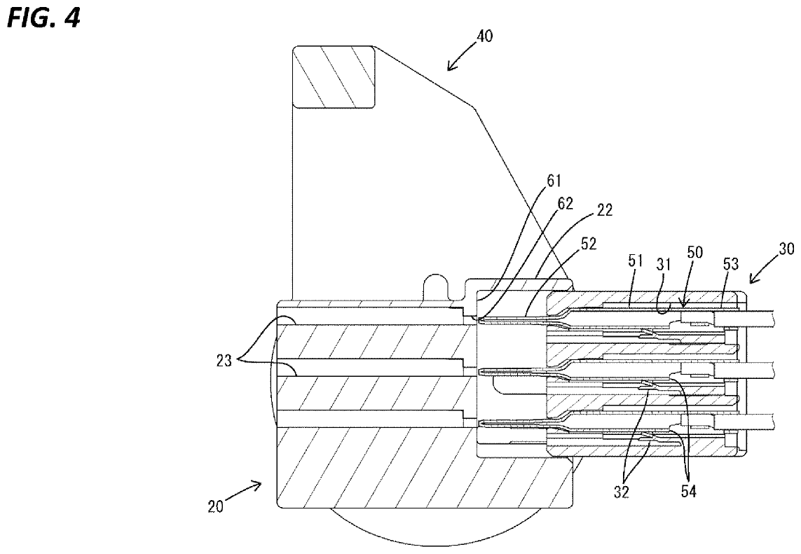

The first housing 20 is made of synthetic resin. As shown in FIG. 1, the first housing 20 includes a terminal accommodating portion 21 and a receptacle 22. The terminal accommodating portion 21 is in the form of a rectangular column Three terminal accommodation chambers 23 extending in the front-rear direction are provided in three upper, middle and lower stages in the terminal accommodating portion 21. The female terminal fittings (not shown) are inserted into the terminal accommodation chambers 23 from front. Five female terminal fittings (not shown) are accommodated in parallel in the lateral direction into the terminal accommodation chamber 23. As shown in FIG. 4, the terminal accommodation chamber 23 communicates with the receptacle 22 via five insertion holes 62 to be described later. As shown in FIG. 1, recesses 24 recessed into a rectangular shape are provided on both corner parts (both corner parts parallel to the front-rear direction) on a lower end side of the terminal accommodating portion 21 when viewed from the front-rear direction.

As shown in FIG. 1, the terminal accommodating portion 21 is provided with a pair of rotary shafts 25, a pair of first restricting pins (restricting pins) 26, a pair of second restricting pins 27 and a pair of connection position receiving portions 28. Note that only the right rotary shaft 25 and the right connection position receiving portion 28 are seen as the rotary shaft 25 and the connection position receiving portion 28 in FIG. 1. The rotary shafts 25 project from the outer surfaces of both left and right walls of the terminal accommodating portion 21. The rotary shafts 25 constitute a center of rotation of the lever 40 by being fit into bearing holes 71 of the lever 40 to be described later. The rotary shaft 25 includes a shaft portion 25A and a rib 25B. The shaft portion 25A is in the form of a cylinder projecting from the outer surface of the left or right wall of the terminal accommodating portion 21. The rib 25B projects from the tip surface of the shaft portion 25A. A cross-section (cross-section orthogonal to the lateral direction) of the rib 25B has a rectangular shape. Two surfaces of the rib 25B along a longitudinal direction are parallel to each other.

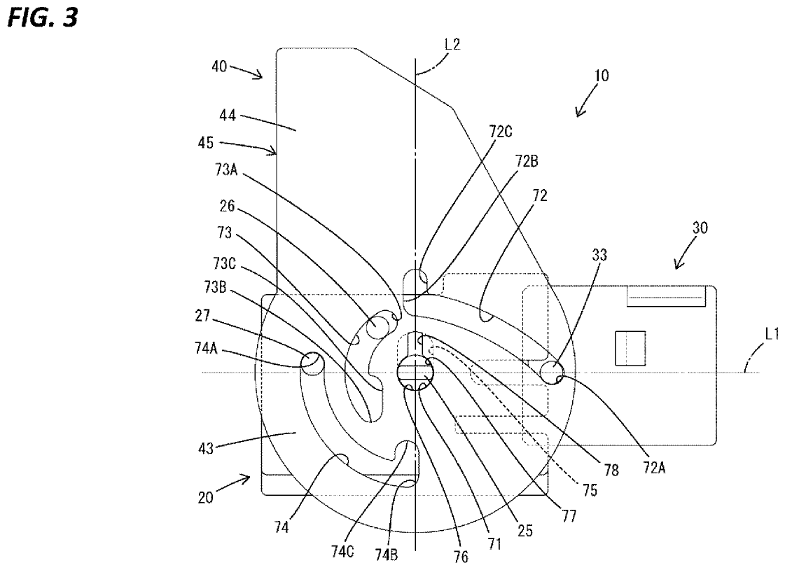

The first restricting pins 26 project from the outer surfaces of the both left and right walls of the terminal accommodating portion 21. The first restricting pins 26 slide in contact with first restricting grooves 73 of the lever 40 to be described later. As shown in FIG. 1, the first restricting pin 26 has a cylindrical shape. As shown in FIG. 3, the first restricting pin 26 is arranged at a position deviated in a direction intersecting a connecting direction (front-rear direction) of the first and second housings 20, 30 with respect to a virtual connection line L1. The virtual connection line L1 is a line passing through the center of rotation (rotary shafts 25) of the lever 40 and parallel to the connecting direction of the first and second housings 20, 30. The first restricting pin 26 is arranged apart from the rotary shaft 25 toward front and upper sides. The first and second restricting pins 26, 27 are arranged in the same region (upper region), out of two regions (upper region and lower region in FIG. 3) of the first housing 20 partitioned by the virtual connection line L1.

The second restricting pins 27 project from the outer surfaces of the both left and right walls of the terminal accommodating portion 21. As shown in FIG. 1, the second restricting pins 27 are arranged at positions different from the first restricting pins 26. The second restricting pins 27 slide in contact with second restricting grooves 74 of the lever 40 to be described later. The second restricting pin 27 has a cylindrical shape. As shown in FIG. 3, the second restricting pin 27 is arranged at a position deviated in the direction intersecting the connecting direction (front-rear direction) of the second and second housings 20, 30 with respect to the virtual connection line L1. The second restricting pin 27 is provided forward of the rotary shaft 25 and the first restricting pin 26. The second restricting pin 27 is provided on a side above a center axis of the rotary shaft 25 and below the first restricting pin 26. A distance between the rotary shaft 25 and the second restricting pin 27 is longer than that between the rotary shaft 25 and the first restricting pin 26.

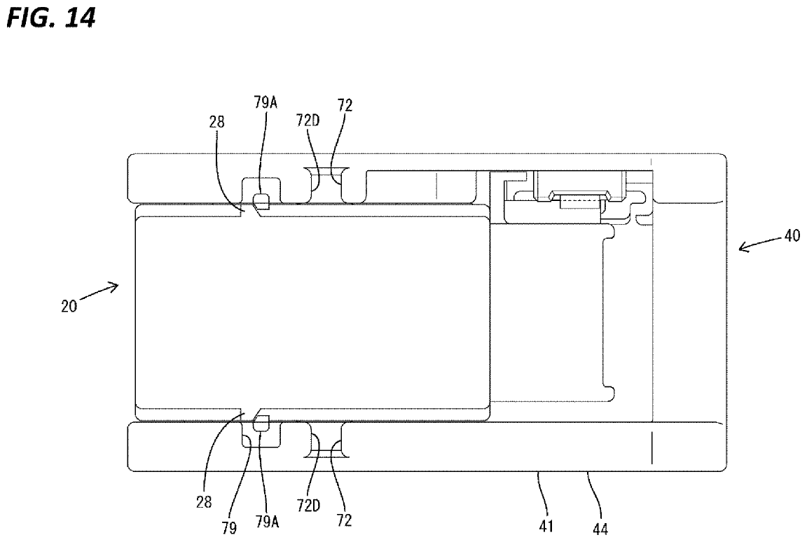

As shown in FIG. 1, the connection position receiving portion 28 is provided in the recess 24. A return restricting portion 79A of the lever 40 to be described later is locked to the connection position receiving portion 28. The connection position receiving portion 28 is provided at a position near a front end side in the recess 24. A cross-section (cross-section orthogonal to the vertical direction) of the connection position receiving portion 28 has a trapezoidal shape narrowed toward a lateral outer side as shown in FIG. 14. The front end surface of the connection position receiving portion 28 is an inclined surface inclined with respect to the lateral direction. The side surface (surface orthogonal to the lateral direction) and the lower end surface of the connection position receiving portion 28 are flush with the outer surface of the terminal accommodating portion 21.

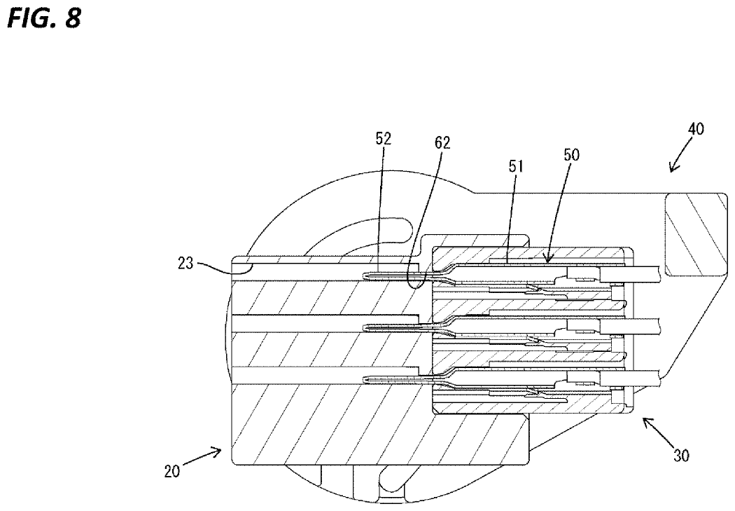

As shown in FIG. 4, the receptacle 22 is in the form of a rectangular tube open rearward. The second housing 30 to be described later is fit into the receptacle 22. Five insertion holes 62 laterally arranged in parallel to correspond to each terminal accommodation chamber 23 are provided in each of three stages in a back wall 61 of the receptacle 22. As shown in FIG. 8, the male terminal fittings 50 are arranged to project into the terminal accommodation chambers 23 via the insertion holes 62.

As shown in FIG. 1, the receptacle 22 is provided with first groove portions 63 and second groove portions 64. The first groove portions 63 are grooves extending forward from the rear end of the receptacle 22. Cam followers 33 of the second housing 30 to be described later are inserted into the first groove portions 63.

As shown in FIG. 1, the second groove portions 64 are grooves extending forward from the rear end of the receptacle 22. The second groove portions 64 are separated downward from the first groove portions 63. Initial position holding portions 34 of the second housing 30 to be described later are inserted into the second groove portions 64.

The second housing 30 is made of synthetic resin. As shown in FIG. 1, the second housing 30 has a rectangular parallelepiped shape. As shown in FIG. 4, the second housing 30 is provided with a plurality of terminal accommodation chambers 31 for accommodating the male terminal fittings 50. The terminal accommodation chambers 31 penetrate through the second housing 30 in the front-rear direction. Five terminal accommodation chambers 31 are arranged in parallel in the lateral direction in each of three upper, middle and lower stages. As shown in FIG. 4, the terminal accommodation chambers 31 are provided with resiliently deformable locking lances 32 projecting from lower walls.

As shown in FIG. 1, the second housing 30 is provided with a pair of the cam followers 33, a pair of the initial position holding portions 34, a lock receiving portion 35 and rotation restricting portions 36. The cam followers 33 project from the outer surfaces of both left and right walls of the second housing 30. The cam followers 33 are provided at positions slightly rearward of the front end of the second housing 30. The cam followers 33 are inserted into cam grooves 72 of the lever 40. In a rotation process of the lever 40 from the initial position to a connection position, the cam followers 33 slide in contact with the cam grooves 72, thereby connecting the first and second housings 20, 30.

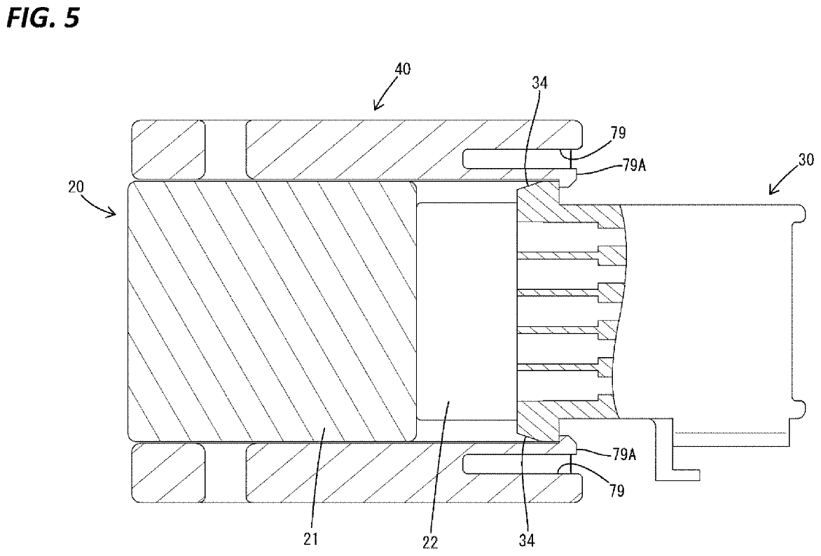

As shown in FIG. 1, the initial position holding portions 34 project from the outer surfaces of the both left and right walls of the second housing 30. The initial position holding portions 34 are provided on the front ends of the both left and right walls of the second housing 30. The initial position holding portions 34 are provided below the cam followers 33. As shown in FIG. 5, the initial position holding portions 34 have a trapezoidal shape when viewed from the vertical direction. A front end side of the initial position holding portion 34 is narrowed in width toward the front. The return restricting portions 79A of the lever 40 to be described later are locked to the initial position holding portions 34.

As shown in FIG. 1, the lock receiving portion 35 is provided on a rear end side in a corner part (corner part parallel to the front-rear direction) on a right-upper end side of the second housing 30. The lock receiving portion 35 is a rib projecting outward in the lateral direction and extending in parallel to the front-rear direction. As shown in FIG. 14, the lock receiving portion 35 is in the form of a hook projecting from the right wall surface of the second housing 30. A lock arm 81 of the lever 40 to be described later is locked to the lock receiving portion 35.

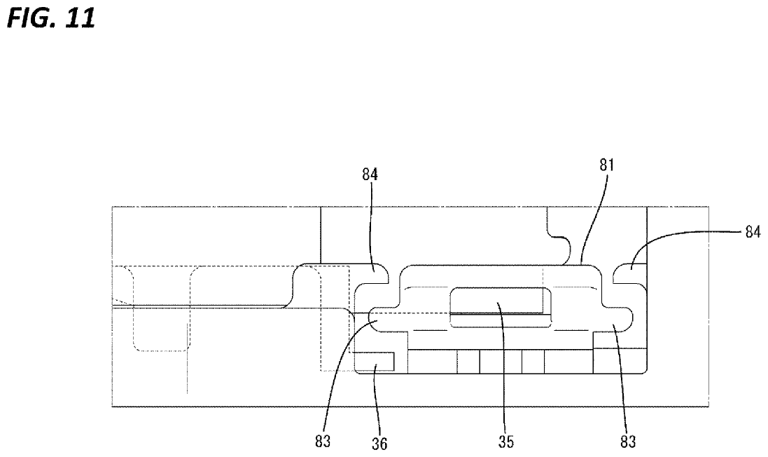

The rotation restricting portions 36 project outward from centers of the both left and right walls of the second housing 30. As shown in FIG. 1, the rotation restricting portion 36 is provided near a center in the front-rear direction of the second housing 30. The rotation restricting portion 36 is provided above a center of the cam follower 33. As shown in FIG. 11, the rotation restricting portion 36 is an L-shaped projecting piece when viewed from the vertical direction. The rotation restricting portion 36 maintains a locked state of the lock arm 81 to the lock receiving portion 35. The rotation restricting portion 36 restricts the deflection and deformation of the lock arm 81 locked to the lock receiving portion 35.

The male terminal fitting 50 is formed by bending a metal plate material. As shown in FIG. 4, the male terminal fitting 50 includes a box portion 51, a tab 52 and a crimping portion 53. The box portion 51 has a rectangular tube shape. A hooking portion 54 penetrating in the vertical direction is provided in the lower wall of the box portion 51. The hooking portion 54 is hooked to the locking lance 32 of the second housing 30, whereby the male terminal fitting 50 is prevented from coming out rearward from the terminal accommodation chamber 31.

The lever 40 is mounted rotatably between an initial position and a connection position with respect to the first housing 20. As shown in FIG. 1, the lever 40 includes a pair of arm portions 41 and a coupling portion 42. As shown in FIG. 3, the arm portion 41 includes a disk portion 43 and an extending portion 44. The disk portion 43 is in the form of a circular plate. The extending portion 44 is in the form of a pentagonal plate. The extending portion 44 extends outward in a radial direction (direction along a straight line L2 shown in FIG. 3) from the disk portion 43. The straight line L2 is a line passing through a center of the disk portion 43 and orthogonal to the virtual connection line L1 when the lever 40 is at the initial position (position shown in FIG. 3). One side edge 45 of the extending portion 44 is parallel to the straight line L2. Plate surfaces of the pair of arm portions 41 are facing each other in the lateral direction. The coupling portion 42 couples the pair of arm portions 41.

As shown in FIG. 3, the arm portion 41 of the lever 40 is provided with the bearing hole 71, the cam groove 72, the first restricting groove 73 and the second restricting groove 74. The bearing hole 71 is a hole penetrating in a plate thickness direction at a center position of the disk portion 43. The rotary shaft 25 of the first housing 20 is fit into the bearing hole 71. The bearing hole 71 includes an inner hole 75 and an outer hole 76. The inner and outer holes 75, 76 communicate in the plate thickness direction of the disk portion 43. The inner hole 75 is provided in an inner part (part on the side of the other disk portion 43) of the disk portion 43. The inner hole 75 has an oval shape long along the straight line L2 (see FIG. 3). The shaft portion 25A of the rotary shaft 25 is inserted into the inner hole 75. The outer hole 76 is provided in an outer part (part on a side opposite to the other disk portion 43) of the disk portion 43. The outer hole 76 is in the form of a keyhole. The outer hole 76 includes a circular hole 77 and a shaft-side recess 78. The circular hole 77 is provided at the center position of the disk portion 43. The shaft-side recess 78 functions as a connection detector. The shaft-side recess 78 is formed by partially recessing the circular hole 77. The shaft-side recess 78 is recessed in a direction parallel to the straight line L2. The rib 25B of the rotary shaft 25 is inserted into the outer hole 76.

As shown in FIG. 3, the cam groove 72 is arcuately provided over a predetermined range around the bearing hole 71 in the disk portion 43. One end 72A of the cam groove 72 is located slightly inwardly of the peripheral edge of the disk portion 43. Another end 72B of the cam groove 72 is located on the straight line L2 of the disk portion 43. The cam groove 72 is shaped to approach a center (bearing hole 71) of the disk portion 43 from the one end 72A toward the other end 72B. The cam follower 33 of the second housing 30 slides in the cam groove 72. The other end 72B of the cam groove 72 is provided with a cam-side recess 72C. The cam-side recess 72C functions as the connection detector. The cam-side recess 72C extends radially outwardly of the disk portion 43 along the straight line L2 from the other end 72B of the cam groove 72. The cam-side recess 72C extends in the same direction as a recess direction of the shaft-side recess 78. A length of the cam-side recess 72C along the straight line L2 is equivalent to that of the shaft-side recess 78 along the straight line L2. The cam follower 33 enters the cam-side recess 72C. The disk portion 43 is provided with an opening 72D (see FIG. 14) open outward to communicate with the one end 72A of the cam groove 72.

As shown in FIG. 3, the first restricting groove 73 is arcuately provided over a predetermined range around the bearing hole 71 in the disk portion 43. The first restricting groove 73 has an arcuate shape concentric with the center of rotation (rotary shaft 25) of the lever 40. In the rotation process of the lever 40, the first restricting pins 26 of the first housing 20 slide in contact with the first restricting grooves 73. One end 73A of the first restricting groove 73 is provided at a position adjacent to the other end 72B of the cam groove 72. An inner recess 73C is provided at the other end 73B of the first restricting groove 73. The inner recess 73C is formed by partially recessing the cam groove 72. The inner recess 73C extends from the other end 73B toward the one end 73A in parallel to the straight line L2. A length of the inner recess 73C along the straight line L2 is equivalent to those of the cam-side recess 72C and the shaft-side recess 78 along the straight line L2.

As shown in FIG. 3, the second restricting groove 74 is arcuately provided over a predetermined range around the bearing hole 71 in the disk portion 43. The second restricting groove 74 has an arcuate shape concentric with the center of rotation (rotary shaft 25) of the lever 40. The second restricting groove 74 is provided closer to the bearing hole 71 than the first restricting groove 73 in the disk portion 43. One end 74A of the second restricting groove 74 is provided slightly on the side of the extending portion 44 (upper side in FIG. 3) with respect to the virtual connection line L1. Another end 74B of the second restricting groove 74 is provided with a detection recess 74C. The detection recess 74C functions as the connection detector. The detection recess 74C is formed by partially recessing the second restricting groove 74. The detection recess 74C extends radially inwardly of the disk portion 43 along the straight line L2 from the other end 74B of the second restricting groove 74. The detection recess 74C extends in the same direction as the recess direction of the shaft-side recess 78 and an extending direction of the inner recess 73C. A length of the detection recess 74C along the straight line L2 is equivalent to those of the cam-side recess 72C and the shaft-side recess 78 along the straight line L2. The second restricting pin 27 enters the detection recess 74C.

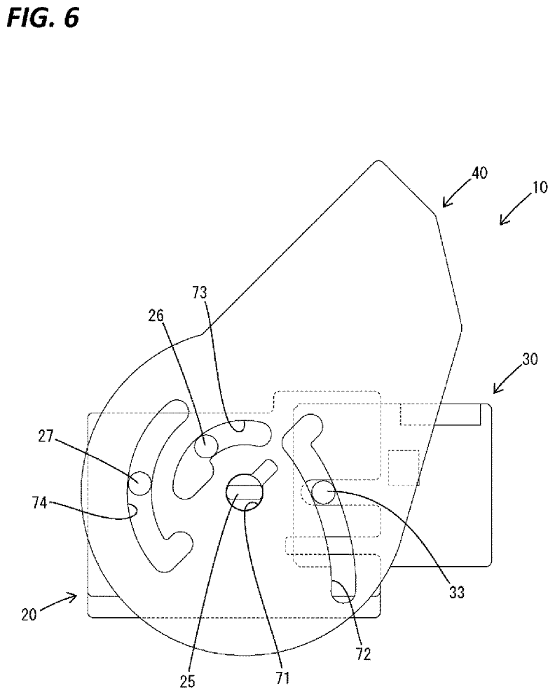

In the lever 40, a groove portion 79 is provided at a position adjacent to the opening 72D on a side opposite to the extending portion 44 as shown in FIGS. 6 and 14. The groove portion 79 is formed by recessing the inner surface (surface on the side of the other arm portion 41) of the arm portion 41. The groove portion 79 extends in a direction orthogonal to the straight line L2. The return restricting portion 79A is provided on the back surface of the groove portion 79. The return restricting portion 79A is a resilient piece extending from the back surface of the groove portion 79 toward an opening. The tip of the return restricting portion 79A projects toward the other return restricting portion 79A. The return restricting portion 79A is locked to the connection position receiving portion 28 of the first housing 20 when the lever 40 is at a connection detecting position. The return restricting portion 79A is locked to the initial position holding portion 34 of the second housing 30 when the lever 30 is at the initial position. By such a configuration, it is not necessary to form a dedicated part for holding the lever 40 at the initial position, separately from the return restricting portions 79A, and the shape of the lever 40 can be simplified.

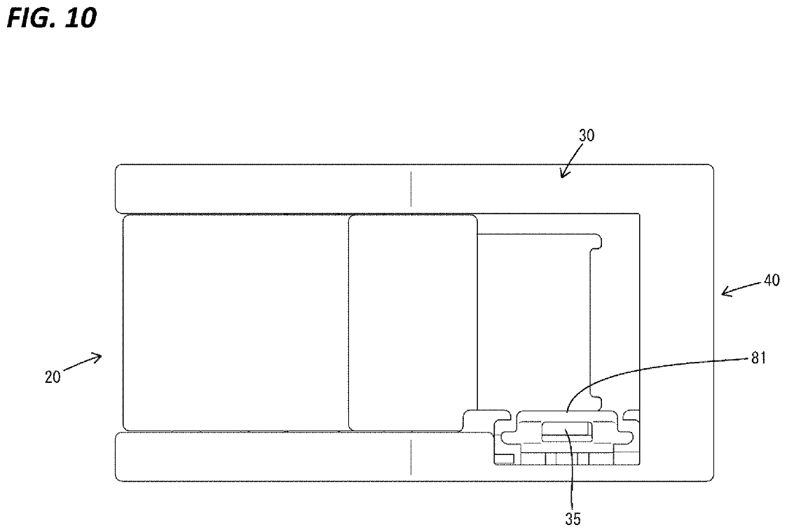

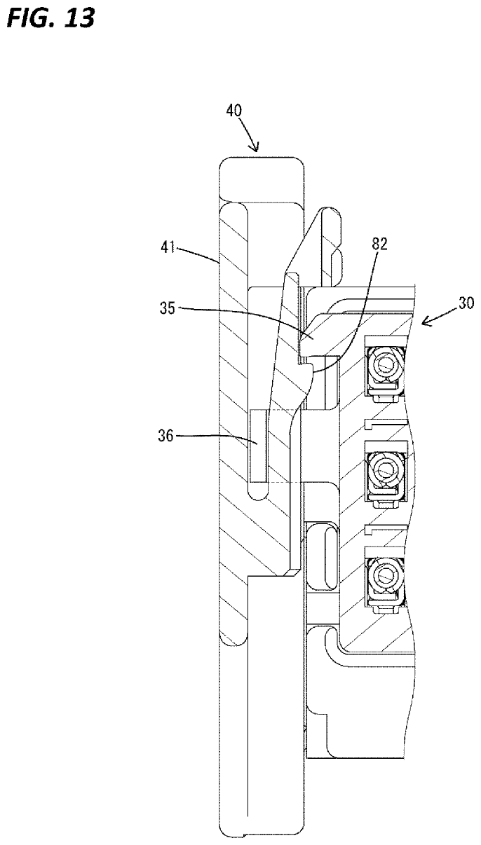

As shown in FIGS. 10 and 13, the lever 40 is provided with the deflectable and deformable lock arm 81. The lock arm 81 projects from the inner surface (surface on the side of the other arm portion 41) of the right arm portion 41. The lock arm 81 extends toward the one side edge 45 of the extending portion 44. The lock arm 81 is provided with a projection 82 at a halfway position in an extending direction as shown in FIG. 13. The projection 82 is locked to the lock receiving portion 35. As shown in FIG. 11, projecting pieces 83 respectively projecting forward and rearward are provided on the tip of the lock arm 81. The lever 40 is provided with a pair of restricting pieces 84 respectively facing the pair of projecting pieces 83 in the lateral direction. By the interference of the projecting pieces 83 with the restricting pieces 84, excessive deflection of the lock arm 81 is restricted.

(Assembling Process of Lever-Type Connector)

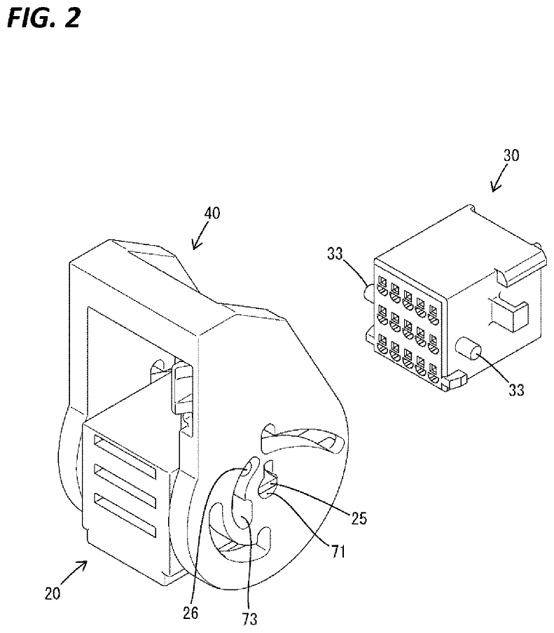

An assembling process of the lever-type connector 10 is described. As shown in FIG. 2, the lever 40 is assembled with the first housing 20. As shown in FIGS. 3 to 5, the first housing 20 is inserted into between the pair of arm portions 41 of the lever 40. As shown in FIG. 2, the bearing holes 71 of the lever 40 are fit to the rotary shafts 25 of the first housing 20. The first restricting pins 26 of the first housing 20 are inserted into the first restricting grooves 73 of the lever 40. The second restricting pins 27 of the first housing 20 are inserted into the second restricting grooves 74 of the lever 40 (see FIG. 3). In this way, the lever 40 is mounted rotatably about the rotary shafts 25 between the initial position and the connection position (rotation operation position) with respect to the first housing 20.

As shown in FIGS. 3 to 5, the second housing 30 is assembled with the first housing 20 and the lever 40 in the assembled state. As shown in FIG. 4, the second housing 30 is inserted into a tip part of the receptacle 22 of the first housing 20. As shown in FIG. 2, the cam followers 33 are inserted into the one ends 72A of the cam grooves 72 via the openings 72D (see FIG. 14). As shown in FIG. 5, the return restricting portions 79A of the lever 40 are locked to the initial position holding portions 34 of the second housing 30. In this way, the lever 40 is held at the initial position by the initial position holding portions 34. The rotary shaft 25 of the first housing 20 are fit into the bearing holes 71. As shown in FIG. 3, the straight line L2 is orthogonal to the virtual connection line L1 when the lever 40 is at the initial position.

As shown in FIG. 3, the rib 25B of the rotary shaft 25B is located in the circular hole 77 of the bearing hole 71 when the lever 40 is at the initial position. Two surfaces of the rib 25B parallel to each other are orthogonal to the recess direction of the shaft-side recess 78. The cam follower 33 is located at the one end 72A of the cam groove 72. The first restricting pin 26 is located at the one end 73A of the first restricting groove 73. The second restricting pin 27 is located at the one end 74A of the second restricting groove 74.

If being tilted rearward, the lever 40 starts to rotate about the rotary shafts 25 as shown in FIG. 6. In the rotation process of the lever 40 from the initial position to the connection position, the cam followers 33 slide in contact with the first groove portions 63. The first restricting pins 26 slide in contact with the first restricting grooves 73. The second restricting pins 27 slide in contact with the second restricting grooves 74. As the cam followers 33 slide in contact with the first groove portions 63, the connection of the first and second housings 20, 30 is started. A force to make the first and second housings 20, 30 oblique with the cam followers 33 as fulcrums acts on the first and second housings 20, 30 being connected. However, the first and second housings 20, 30 can be prevented from becoming oblique by the contact of the first restricting pins 26 and the first restricting grooves 73 and the contact of the second restricting pins 27 and the second restricting grooves 74.

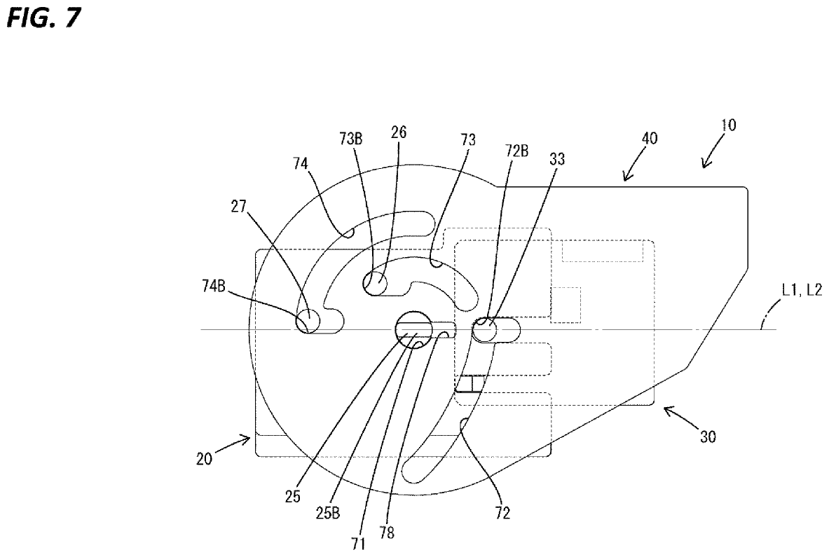

As shown in FIG. 7, the lever 40 is rotated to the connection position. When the lever 40 is at the connection position, the cam followers 33 are located at the other ends 72B of the cam grooves 72. The first restricting pins 26 are located at the other ends 73B of the first restricting grooves 73. The second restricting pins 27 are located at the other ends 74B of the second restricting grooves 74. As shown in FIG. 7, when the lever 40 is at the connection position, the straight line L2 is parallel to the virtual connection line L1. If the lever 40 reaches the connection position, the first and second housings 20, 30 are connected in an opposed positional relationship as shown in FIG. 8. The male terminal fittings 50 are arranged to project into the terminal accommodation chambers 23 via the insertion holes 62. In this way, the male terminal fittings 50 are connected to the female terminal fittings (not shown).

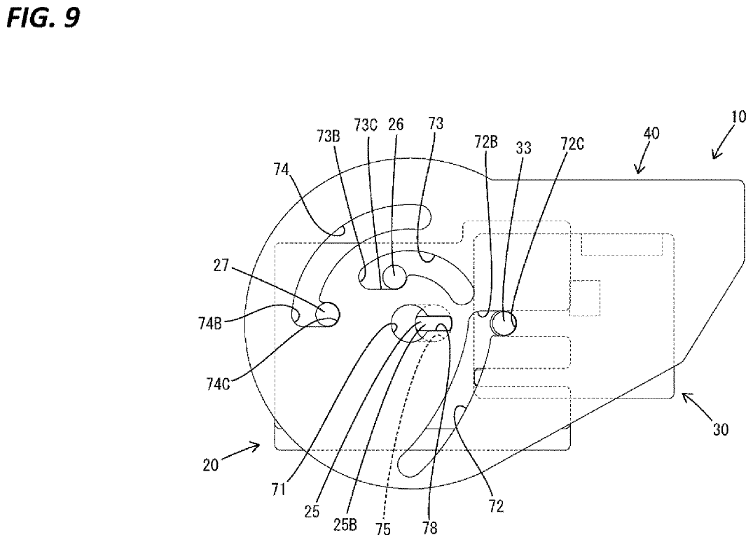

Only when the lever 40 reaches the connection position and the first and second housings 20, 30 are connected in the opposed positional relationship, the lever 40 is allowed to slide to the connection detecting position eccentric from the rotary shafts 25 as shown in FIG. 9. When the lever 40 is at the connection position, the two surfaces of the rib 25B of each rotary shaft 25 parallel to each other are parallel to the recess direction of the shaft-side recess 78. In this way, the ribs 25B enter the shaft-side recesses 78 in the process of sliding the lever 40 to the connection detecting position. The cam followers 33 enter the cam-side recesses 72C. The first restricting pins 26 slide toward the one ends 73A in the inner recesses 73C. The second restricting pins 27 enter the detection recesses 74C. The first and second housings 20, 30 can be connected in the opposed state and the connection of the both housings 20, 30 can be detected. The connection of the both housings 20, 30 can be detected using the cam followers 33. The connection of the both housings 20, 30 can be detected using the second restricting portions 27. The connection of the both housings 20, 30 can be detected using the rotary shafts 25.

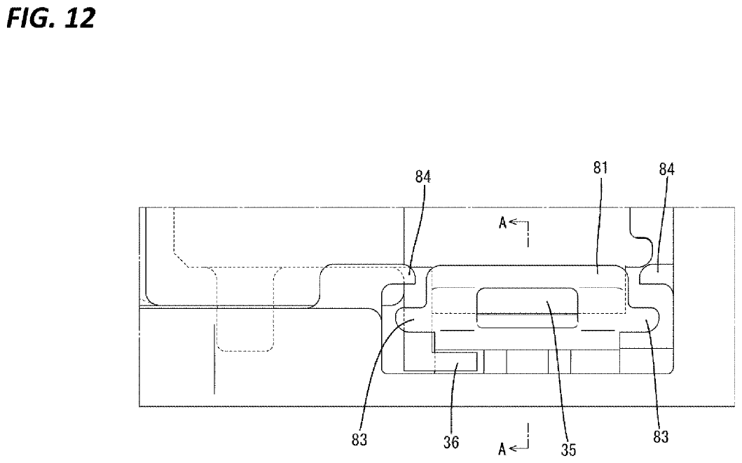

In the process of sliding the lever 40 to the connection detecting position, the lock arm 81 locks the lock receiving portion 35 of the second housing 30 as shown in FIGS. 12 and 13. The rotation restricting portion 36 moves from a non-restricting position for the lock arm 81 shown in FIG. 11 to a restricting position for the lock arm 81 shown in FIG. 12. The tip of the rotation restricting portion 36 is located between the lock arm 81 and the right arm portion 41. In this way, the deflection and deformation of the lock arm 81 toward the right arm portion 41 are restricted and the state of the lock arm 81 locking the lock receiving portion 35 is maintained. Thus, the rotation of the lever 40 toward the initial position is restricted.

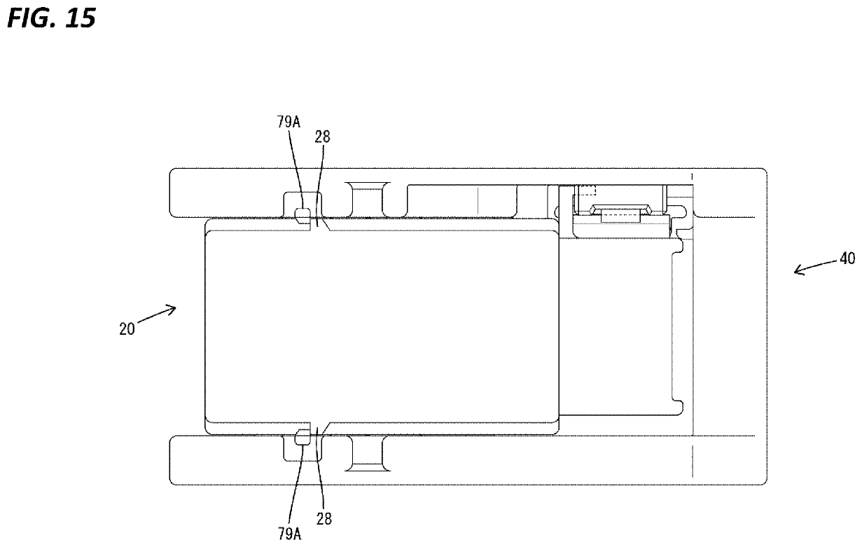

In the process of sliding the lever 40 to the connection detecting position, the return restricting portions 79A move from a non-locking position for the connection position receiving portions 28 shown in FIG. 14 to a locking position for the connection position receiving portions 28 shown in FIG. 15. In a moving process from the non-locking position to the locking position, the return restricting portions 79A are pressed by the connection position receiving portions 28 to be deflected and deformed outward in the lateral direction. The return restricting portions 79A resiliently return and are locked to the connection position receiving portions 28 when riding over the connection position receiving portions 28. In this way, the return of the lever 40 to the rotation operation position where a rotation operation is performed is restricted.

### Effects of Embodiment

As described above, according to the lever-type connector 10 of the present disclosure, a force to make the first and second housings 20, 30 oblique with the cam followers 33 as fulcrums acts on the first and second housings 20, 30 being connected. However, the first and second housings 20, 30 can be prevented from becoming oblique by the contact of the first restricting pins 26 and the first restricting grooves 73. If the lever 40 rotates to the connection position, the first and second housings 20, 30 are connected in the opposed state and the lever 40 can be slid to the connection detecting position. According to the present disclosure, the first and second housings 20, 30 can be connected in the opposed state and the connection of the both housings 20, 30 can be detected.

The cam-side recesses 72 of the present disclosure are formed by partially recessing the cam grooves 72 and the cam followers 33 enter the cam-side recesses 72C in the process of sliding the lever 40 to the connection detecting position. According to this configuration, the connection of the both housings 20, 30 can be detected using the cam followers 33.

The first housing 20 of the present disclosure is formed with the second restricting pins 27 arranged at the positions different from the first restricting pins 26, and the lever 40 is formed with the second restricting grooves 74, which have an arcuate shape concentric with the center of rotation of the lever 40 and with which the second restricting pins 27 slide in contact in the rotation process of the lever 40. According to this configuration, an event in which the first and second housings 20, 30 become oblique with the cam followers 33 as fulcrums can be reliably prevented by the contact action of the second restricting pins 27 and the second restricting grooves 74 in addition to the contact action of the first restricting pins 26 and the first restricting grooves 73.

The detection recesses 74C of the present disclosure are formed by partially recessing the second restricting grooves 74 and the second restricting pins 27 enter the detection recesses 74C in the process of sliding the lever 40 to the connection detecting position. According to this configuration, the connection of the both housings 20, 30 can be detected using the second restricting pins 27.

The first housing 20 of the present disclosure is formed with the rotary shafts 25 constituting the center of rotation of the lever 40 by being fit into the bearing holes 71 of the lever 40. The shaft-side recesses 78 are formed by partially recessing the bearing holes 71, and the rotary shafts 25 enter the shaft-side recesses 78 in the process of sliding the lever 40 to the connection detecting position. According to this configuration, the connection of the both housings 20, 30 can be detected using the rotary shafts 25.

The first housing 20 of the present disclosure is formed with the rotation restricting portions 36 for restricting the rotation of the lever 40 toward the initial position with the lever 40 slid to the connection detecting position. According to this configuration, if the lever 40 is slid to the connection detecting position, the rotation of the lever 40 toward the initial position is restricted by the rotation restricting portion 36. Thus, the first and second housings 20, 30 can be maintained in the connected state.

The lever 40 of the present disclosure is preferably formed with the return restricting portions 79A for restricting the return of the lever 40 to the rotation operation position where the rotation operation is performed by being locked to the first housing 20 when the lever 40 is slid to the connection detecting position. According to this configuration, the lever 40 can be held at the connection detecting position.

The second housing 30 of the present disclosure is formed with the initial position holding portions 34 for holding the lever 40 at the initial position by being locked to the return restricting portions 79A. According to this configuration, the shape of the lever 40 can be simplified as compared to the case where a dedicated part for holding the lever 40 at the initial position is formed, separately from the return restricting portions 79A.

### Other Embodiments

The present invention is not limited to the above described and illustrated embodiment, but is represented by claims. The present invention is intended to include all changes in the scope of claims and in the meaning and scope of equivalents and also include the following embodiments.

Although the cam groove 72 is formed with the cam-side recess 72C for exhibiting a function as the connection detector in the above embodiment, the cam groove 72 may not include a part for exhibiting a function as the connection detector.

Although the inclination of the first and second housings 20, 30 is prevented by the contact of the second restricting pins 72 and the second restricting grooves 74 in addition to the contact of the first restricting pins 26 and the first restricting grooves 73 in the above embodiment, the inclination of the first and second housings 20, 30 may be prevented only by the contact of the first restricting pins 26 and the first restricting grooves 73.

Although the first and second restricting pins 26, 27 are arranged in the same region, out of the two regions of the first housing 20 partitioned by the virtual connection line L1, in the above embodiment, the first and second restricting pins 26, 27 may be arranged in the regions on opposite sides across the virtual connection line L1.

Although the second restricting groove 74 is formed with the detection recess 74C for exhibiting a function as the connection detector in the above embodiment, the second restricting groove 74 may not include a part for exhibiting a function as the connection detector.

Although the bearing hole 71 is formed with the shaft-side recess 78 for exhibiting a function as the connection detector in the above embodiment, the bearing hole 71 may not include a part for exhibiting a function as the connection detector.

Although the rotation restricting portions 36 are formed on the second housing 30 in the above embodiment, rotation restricting portions may be formed on the first housing 20.

Although the return restricting portions 79A also have a function of holding the lever 40 at the initial position in the above embodiment, a dedicated part for holding the lever 40 at the initial position may be formed, separately from the return restricting portions 79A.

### LIST OF REFERENCE NUMERALS

10 . . . lever-type connector
20 . . . first housing
21 . . . terminal accommodating portion
22 . . . receptacle
23 . . . terminal accommodation chamber
24 . . . recess
25 . . . rotary shaft
25A . . . shaft portion
25B . . . rib
26 . . . first restricting pin (restricting portion)
27 . . . second restricting pin
28 . . . connection position receiving portion
30 . . . second housing
31 terminal accommodation chamber
32 . . . locking lance
33 . . . cam follower
34 . . . initial position holding portion
35 . . . lock receiving portion
36 . . . rotation restricting portion
40 . . . lever
41 . . . arm portion
42 . . . coupling portion
43 . . . disk portion
44 . . . extending portion
45 . . . one side edge of extending portion
50 . . . male terminal fitting
51 . . . box portion
52 . . . tab
53 . . . crimping portion
54 . . . hooking portion
61 . . . back wall
62 . . . insertion hole
63 . . . first groove portion
64 . . . second groove portion
70 . . . lever
71 . . . bearing hole
72 . . . cam groove
72A . . . one end
72B . . . other end
72C . . . cam-side recess
72D . . . opening
73 . . . first restricting groove (restricting groove)
73A . . . one end
73B . . . other end
73C . . . inner recess
74 . . . second restricting groove
74A . . . one end
74B . . . other end
74C . . . detection recess
75 . . . inner hole
76 . . . outer hole
77 . . . circular hole
78 . . . shaft-side recess
79 . . . groove portion
79A . . . return restricting portion
81 . . . lock arm
82 . . . projection
83 . . . projecting piece
84 . . . restricting piece
L1 . . . virtual connection line
L2 . . . straight line

1. A lever-type connector, comprising:
a first housing;
a second housing connectable to the first housing;
a lever including a cam groove, the lever being mounted rotatably between an initial position and a connection position with respect to the first housing;
a cam follower formed on the second housing, the cam follower connecting the first and second housings by sliding in contact with the cam groove in a rotation process of the lever from the initial position to the connection position;
a restricting pin provided on the first housing, the restricting pin being arranged at a position deviated in a direction intersecting a connecting direction of the first and second housings with respect to a virtual connection line passing through a center of rotation of the lever and parallel to the connecting direction;
a restricting groove formed in the lever, the restricting groove having an arcuate shape concentric with the center of rotation of the lever, the restricting pin sliding in contact with the restricting groove in the rotation process of the lever; and
a connection detector for allowing the lever to slide to a connection detecting position eccentric from the center of rotation only when the lever reaches the connection position and the first and second housings are connected in an opposed positional relationship.

2. The lever-type connector of claim 1, wherein the connection detector includes a cam-side recess formed by partially recessing the cam groove, the cam follower entering the cam-side recess in the process of sliding the lever to the connection detecting position.

3. The lever-type connector of claim 1, wherein:
the first housing is formed with a second restricting pin arranged at a position different from the restricting pin, and
the lever is formed with a second restricting groove having an arcuate shape concentric with the center of rotation of the lever and configured such that the second restricting pin slides in contact therewith in the rotation process of the lever.

4. The lever-type connector of claim 3, wherein the connection detector includes a detection recess formed by partially recessing the second restricting groove, the second restricting pin entering the detection recess in the process of sliding the lever to the connection detecting position.

5. The lever-type connector of claim 1, wherein:
the first housing is formed with a rotary shaft constituting the center of rotation of the lever by being fit into a bearing hole of the lever, and
the connection detector includes a shaft-side recess formed by partially recessing the bearing hole, the rotary shaft entering the shaft-side recess in the process of sliding the lever to the connection detecting position.

6. The lever-type connector of claim 1, wherein the first or second housing is formed with a rotation restricting portion for restricting rotation of the lever toward the initial position with the lever slid to the connection detecting position.

7. The lever-type connector of claim 1, wherein the lever is formed with a return restricting portion for restricting return of the lever to a rotation operation position where a rotation operation is performed by being locked to the first housing when the lever is slid to the connection detecting position.

8. The lever-type connector of claim 7, wherein the second housing is formed with an initial position holding portion for holding the lever at the initial position by being locked to the return restricting portion.
